(19) United States
(12) Patent Application Publication
(10) Pub. No.: US 2026/0091372 A1
(43) Pub. Date: Apr. 2, 2026

(54) Catalyst For Ammonia Cracking And Method Of Manufacturing The Same

(71) Applicant: HEESUNG CATALYSTS CORPORATION, Siheung-si (KR)

(72) Inventors: Ho-Dong KIM, Namyangju-si (KR); Minsik KIM, Siheung-si (KR); Jinwoo SONG, Incheon (KR)

(21) Appl. No.: 19/341,199

(22) Filed: Sep. 26, 2025

(30) Foreign Application Priority Data
Oct. 2, 2024 (KR) 10-2024-0134275

(51) Int. Cl. B01J 23/58; B01J 21/04; B01J 37/02; B01J 37/08; C01B 3/04

(52) U.S. Cl. CPC B01J 23/58; B01J 21/04; B01J 37/0201; B01J 37/0215; B01J 37/08; C01B 3/047

(57) ABSTRACT

Provided are a catalyst for ammonia cracking, and a method of manufacturing the same. The catalyst for ammonia cracking includes a alumina-metal foam composite; and a functional layer on the alumina-metal foam composite, wherein the alumina-metal foam composite includes a metal foam and an alumina layer on the metal form, and the functional layer includes a porous carrier and an active metal supported in the porous carrier.

### CROSS-REFERENCE TO RELATED APPLICATION

This application claims priority to and the benefit of Korean Patent Application No. 10-2024-0134275 filed with the Korean Intellectual Property Office on Oct. 2, 2024, the entire contents of which are incorporated herein by reference.

### BACKGROUND OF THE INVENTION

### (a) Field of the Invention

A catalyst for ammonia cracking is disclosed.

### (b) Description of the Related Art

Recently, the demand for energy has increased worldwide due to industrial development and population growth, while fossil fuels, which are used as energy sources, are gradually being depleted. In addition, faced with global warming and climate change caused by greenhouse gases, each country is continuously searching for new growth engines in climate technology and energy materials that can create economic benefits, while contributing to curbing the global warming. Among them, the most actively researched as an environment-friendly energy source is hydrogen, which is believed to be a potential energy source that can replace most of the existing energy consumption, a clean energy source that contains no carbon, a main substance of carbon dioxide, and a promising energy source that has the highest calorific value among combustion substances. In addition, since hydrogen is used as a raw material for fuel cells, which are classified as a type of renewable energy, the demand is expected to increase explosively in the future.

For this reason, much research has recently been conducted on an ammonia cracking reaction process through which hydrogen is produced from ammonia as an eco-friendly hydrogen production technology.

Ammonia (NH₃) is an excellent candidate for storage and transportation, because ammonia has a higher volumetric hydrogen density per unit weight or unit volume than high-pressure hydrogen or liquid hydrogen and can be liquefied and stored at a pressure of 10 bar or less when compressed at room temperature. Additionally, because ammonia is liquid at lower pressures and higher temperatures than hydrogen, ammonia is inexpensive to liquefy and convenient to store and transport. Furthermore, ammonia is a carbon-free raw material and generates no carbon dioxide during the hydrogen-producing process. The current ammonia industry is so massive as to use about 50% of global hydrogen production for fertilizer production. Accordingly, there is also an advantage of utilizing the existing ammonia plants and processes similarly in terms of production and supply.

An ammonia cracking reaction is a decomposition reaction of ammonia into hydrogen and nitrogen, which corresponds to an endothermic reaction, wherein an amount of heat required for the reaction depending on a composition at thermodynamic equilibrium and an ammonia supply flow rate is as follows.

NH₃↔1.5H₂+0.5N₂, ΔH=46.2 kJ/mol

On the other hand, unlike the current steam reforming process of natural gas required of a temperature of about 700° C., the ammonia decomposition may be carried out at a temperature of about 450° C. to 500° C. at equilibrium conversion, resulting in relatively low energy costs. However, because the ammonia cracking reaction is an endothermic reaction and actually carried out at 500° C. or higher, in order to increase energy efficiency, a catalyst is being developed to enable the ammonia decomposition reaction to occur at lower temperatures.

### SUMMARY OF THE INVENTION

An embodiment provides a catalyst for ammonia cracking that prevents a detachment phenomenon between a support and catalyst powder and has high ammonia cracking efficiency even at low temperatures.

Another embodiment provides a method of manufacturing a catalyst for ammonia cracking.

A catalyst for ammonia cracking according to an embodiment includes an alumina-metal foam composite; and a functional layer on the alumina-metal foam composite, wherein the alumina-metal foam composite includes a metal foam and an alumina layer on the metal form, and the functional layer includes a porous carrier, and an active metal supported in the porous carrier.

A weight ratio of the alumina-metal foam composite and the functional layer in the catalyst for ammonia cracking may be 90:10 to 60:40.

The active metal may be included in an amount of 0.5 wt % to 3.0 wt % based on a total weight of the catalyst.

The alumina in the alumina layer may include gamma-alumina, delta-alumina, eta-alumina, theta-alumina, or a combination thereof.

The metal form may include an alloy in which at least two or more of aluminum, nickel, chromium, copper, titanium, silver, tungsten, and iron are combined.

The metal form may have a three-dimensional asymmetric structure.

The metal foam may have a porosity of greater than or equal to 80 vol %.

A weight ratio of the metal foam and the alumina layer in the alumina-metal foam composite may be 99:1 to 95:5.

The active metal may include ruthenium (Ru), lanthanum (La), nickel (Ni), cobalt (Co), iron (Fe), cerium (Ce), or a combination thereof.

The active metal may include lanthanum and ruthenium in a weight ratio of 3:1 to 1:1.

The porous carrier may be a spinel-type carrier.

The spinel-type carrier may include MgAl₂O₄ or CaAl₂O₄.

A weight ratio of the porous carrier and the active metal in the functional layer may be 96:4 to 85:15.

The catalyst may further include potassium, sodium, rubidium, cesium, or a combination thereof.

The catalyst may include potassium and ruthenium in a weight ratio of 3:1 to 1:1.

The catalyst may have an ammonia cracking efficiency of greater than or equal to 95% at 400° C. to 550° C.

A method of manufacturing a catalyst for ammonia cracking according to another embodiment includes a) impregnating a solution including an alumina sol into a metal foam to manufacture an alumina-metal foam composite including a metal foam and an alumina layer on the metal foam; b) supporting an active metal on a porous carrier to prepare a composition for a functional layer; and c) coating the functional layer composition on the alumina-metal foam composite to obtain a final catalyst.

The a) manufacturing of the alumina-metal foam composite may further include a-1) supporting the solution including the alumina sol on a metal form; and then, a-2) heat treating a product obtained in the a-1) to manufacture the alumina-metal foam composite.

The b) preparing of the composition for the functional layer may include b-1) heat-treating a porous carrier; b-2) supporting a lanthanum precursor solution into the obtained product of the b-1) and then drying and heat-treating it; b-3) supporting a ruthenium precursor solution into the obtained product of the b-2) and then drying and heat-treating it.

The c) obtaining of the final catalyst may include c-1) carrying out drying and heat treatment after supporting a solution including the composition for the functional layer on the alumina-metal foam composite.

After the c-1), the method may further include c-2) supporting a solution including an alkali metal into the obtained product of the c-1), followed by drying and heat treatment.

After the c-1) or the c-2), the method may further include c-3) reducing the product obtained in the c-1) or the c-2) by treating it in a hydrogen atmosphere.

The catalyst for ammonia cracking according to an embodiment suppresses the detachment phenomenon between the support and the catalyst powder and has excellent ammonia cracking efficiency at low temperatures.

### BRIEF DESCRIPTION OF THE DRAWINGS

FIG. 1 is a photograph of a metal foam not supporting alumina observed using an image microscope.

FIG. 2 is a photograph of a metal foam not supporting alumina observed using a scanning electron microscope.

FIG. 3 is a photograph of a metal foam support supporting alumina observed using an image microscope.

FIG. 4 is a photograph of a metal foam support supporting alumina observed using a scanning electron microscope.

FIG. 5 is a photograph of a catalyst for ammonia cracking according to Example 1 observed using an image microscope.

FIG. 6 is a photograph of a catalyst for ammonia cracking according to Example 1 observed using a scanning electron microscope.

FIG. 7 is a photograph of the catalyst according to Comparative Example 5 observed using a scanning electron microscope.

FIG. 8 is a graph showing the ammonia cracking reaction efficiency of catalysts according to Examples and Comparative Examples.

### DETAILED DESCRIPTION OF THE EMBODIMENTS

Example embodiments of the present disclosure will hereinafter be described in more detail, and may be easily practiced by a person skilled in the art. However, this disclosure may be embodied in many different forms and is not construed as limited to the example embodiments set forth herein.

The ammonia cracking reaction for a catalyst consists of chemical adsorption of ammonia with a catalyst, dihydrogen reaction of the ammonia, recombination of decomposed nitrogen and hydrogen, and desorption of the nitrogen. A reaction rate of the ammonia cracking reaction is determined by a dissociation rate of a nitrogen-hydrogen bond and a desorption rate of the produced nitrogen from the catalyst and may be optimized by controlling physicochemical characteristics of the catalyst, an active metal and its support, a form of the catalyst, and the like.

On the other hand, an ammonia cracking reactor uses a burner to supply heat, and the catalyst is introduced in the form of a pellet into the reactor, wherein a ceramic material, a component of the pellet, has a slow heat transfer rate, which lowers a temperature of the reactor, deteriorating catalyst efficiency during the endothermic reaction and making a gas flow unsmooth, resulting in a channeling problem that gas does not locally react but passes through.

In order to solve the problem in the ammonia cracking reactor as well as increase the catalyst efficiency, development of a catalyst having high reaction activity, long life-span, high heat transfer, low pressure drop, high thermal durability, and high mechanical strength is underway.

The present inventors have discovered that a metal foam composite rather than the pellet as the catalyst for ammonia cracking, wherein alumina is supported on the metal foam composite, may be used to solve the problem that a differential pressure at the rear end of the reactor occurs without reducing the efficiency of the ammonia cracking reaction.

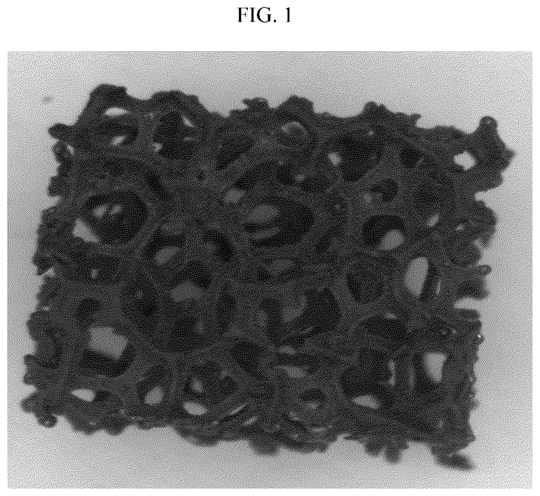

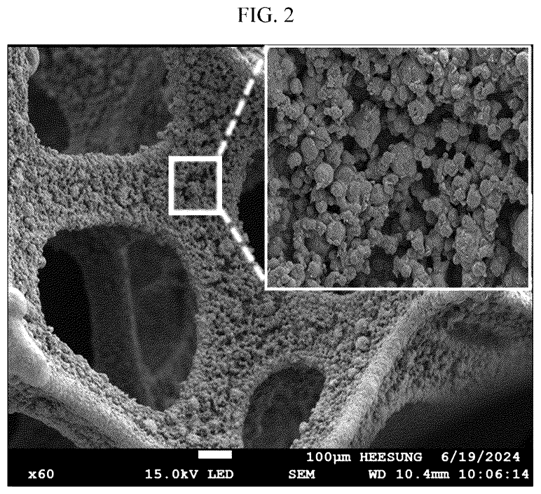

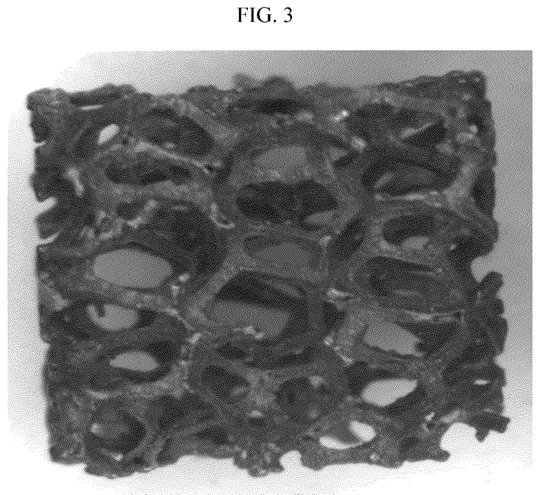

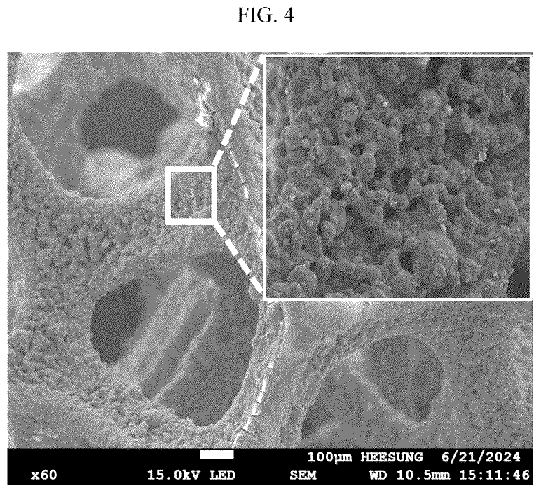

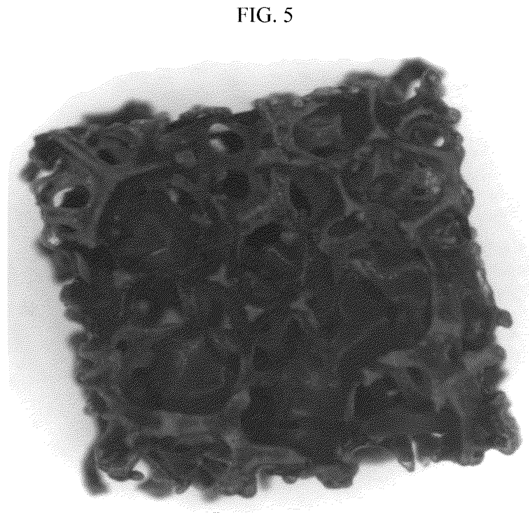

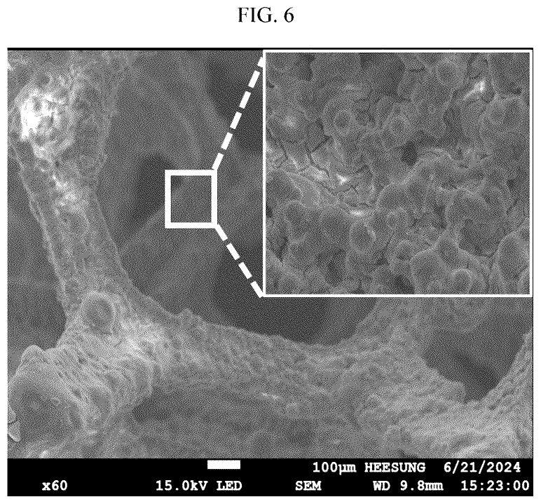

FIGS. 1 and 2 are photographs of a metal foam not supporting alumina observed using an image microscope and a scanning electron microscope, respectively, and FIGS. 3 and 4 are photographs of a metal foam composite supporting alumina observed using an image microscope and a scanning electron microscope, respectively. In addition, FIGS. 5 and 6 are photographs of a catalyst for ammonia cracking according to an embodiment observed using an image microscope and a scanning electron microscope, respectively.

The catalyst for ammonia cracking according to an embodiment includes an alumina-metal foam composite; and a functional layer on the alumina-metal foam composite. The alumina-metal foam composite includes a metal foam and an alumina layer on the metal foam, and the functional layer includes a porous carrier and an active metal supported within the porous carrier.

The alumina-metal foam composite, on which alumina is supported, may increase adhesion between the metal foam and the functional layer without allowing the metal foam and an active component of the catalyst to come into direct contact, resulting in suppressing deterioration of reaction activity due to detachment of the active component in the catalyst and thus the differential pressure phenomenon at the rear end of the reactor but securing excellent reaction efficiency of the catalyst. In addition, if the metal foam comes into direct contact with the active component of the catalyst, the phenomenon that the reaction activity of the catalyst is deteriorated due to detachment of the active component of the catalyst at high temperatures due to a different coefficient of thermal expansion of the metal foam and the active component of the catalyst.

The alumina in the alumina layer included in the alumina-metal foam composite includes gamma-alumina, delta-alumina, eta-alumina, theta-alumina, or a combination thereof. Additionally, the alumina layer may have a specific surface area of greater than or equal to 200 m²/g, or a pore volume of greater than or equal to about 0.4 cm³/g. Since the alumina layer can secure a large specific surface area and pore volume, it may increase adhesive strength to the metal foam and increase reaction activity of the catalyst.

The alumina layer may further include an organic binder. The organic binder further increases a binding strength between alumina and metal foam in the alumina layer, allowing alumina to be coated more uniformly on the metal foam. The organic binder may be, for example, a polymer, a sugar type such as starch, alginic, methyl cellulose, ethyl cellulose, hydroxyethyl cellulose, hydroxypropylmethyl cellulose, hydroxypropylethyl cellulose, hydroxyethylmethyl cellulose, glucose, sucrose, sorbitol, or a combination thereof, but is not limited thereto.

The metal foam included in the alumina-metal foam composite includes an alloy in which at least two or more of aluminum, nickel, chromium, copper, titanium, silver, tungsten, and iron are combined, and may include, for example, an alloy in which at least two or more of aluminum, nickel, and chromium are combined, but is not limited thereto.

The metal form has a three-dimensional asymmetric structure. For example, a three-dimensional asymmetric structure is formed not in a single direction but in a random direction, and an example is a mesh structure in which a three-dimensional asymmetric structure is formed in a random direction. By using the metal foam having the three-dimensional asymmetric structure, ammonia may rapidly diffuse within the catalyst, while the product after the catalytic reaction may quickly move to the outside of the catalyst, thereby increasing the efficiency of the catalyst. In addition, it is possible to secure high mechanical strength of the catalyst while increasing heat transfer within the catalyst.

The metal foam has a porous structure with a porosity of greater than or equal to 80 vol %, for example, greater than or equal to 81 vol %, greater than or equal to 82 vol %, or greater than or equal to 83 vol %, for example, less than or equal to 95 vol %, less than or equal to 94 vol %, less than or equal to 93 vol %, less than or equal to 92 vol %, less than or equal to 91 vol %, or less than or equal to 90 vol %. If the metal foam has a porosity of greater than or equal to 80 vol %, an amount of the active metal used per the same volume of the catalyst may be reduced, and the amount of ammonia that can be cracked, when the same amount of the active metal is used, may be increased, thereby increasing efficiency of the catalyst, while less using expensive metal.

In the alumina-metal foam composite, the metal foam and the alumina layer may have a weight ratio of 99:1 to 95:5. If the weight ratio of the metal foam and the alumina layer in the alumina-metal foam composite is within the range, the alumina layer may maximize adhesion between the metal foam and the functional layer.

The functional layer of the catalyst for ammonia cracking according to an embodiment enables the catalyst to activate the ammonia cracking reaction and includes a porous carrier and the active metal supported on the porous carrier.

The porous carrier enables the active metal to be dispersed and stably supported. The porous carrier may be a spinel-type carrier, for example, magnesium aluminate (MgAl₂O₄) or calcium aluminate (CaAl₂O₄). The spinel-type porous carrier has excellent thermal stability and mechanical strength, so that the porous carrier is not deformed under ammonia cracking reaction temperature conditions and may more stably support the active metal.

The porous carrier may be used without limitation on the type as long as it is a material capable of dispersing and supporting an active metal. For example, magnesium aluminate (MgAl₂O₄), calcium aluminate (CaAl₂O₄), activated carbon, graphite, mesoporous carbon, carbon nanotube, alumina (Al₂O₃), silica (SiO₂), titanium dioxide (TiO₂), zirconia (ZrO₂), cerium oxide (CeO₂), magnesium oxide (MgO), or a combination thereof may be used, and for example, magnesium aluminate (MgAl₂O₄) or calcium aluminate (CaAl₂O₄) may be used, but is not limited thereto. The MgAl₂O₄ or CaAl₂O₄ is a spinel type, has excellent thermal stability and mechanical strength, and may support the active metal more stably without being deformed under ammonia cracking reaction temperature conditions.

The active metals include ruthenium and lanthanum, and other metals that may improve the performance of the catalyst and impart additional functions to the catalyst may be used together within a range that does not lower the efficiency of the catalyst. The ruthenium (Ru) is the main active component of the catalyst, which enables the catalyst to promote the ammonia cracking reaction. The lanthanum (La) may improve the activity, stability, or selectivity of the catalyst, improve the dispersibility of the ruthenium, and further improve the performance of the catalyst.

The active metal may include, for example, ruthenium (Ru), lanthanum (La), nickel (Ni), cobalt (Co), iron (Fe), cerium (Ce), or a combination thereof, and may include, for example, ruthenium, lanthanum, or a combination thereof.

The active metal may include lanthanum and ruthenium in a weight ratio of 3:1 to 1:1, for example, 2.5:1 to 1:1, 2.3:1 to 1:1, 2:1 to 1:1, 1.5:1 to 1:1, but is not limited thereto. By including lanthanum and ruthenium in the weight ratio above as the active metal, the efficiency of the catalyst may be further improved while ensuring the stability of the catalyst.

The lanthanum metal may be supported in an amount of 0.2 wt % to 1.5 wt %, for example, 0.3 wt % to 1.5 wt %, 0.4 wt % to 1.5 wt %, 0.5 wt % to 1.5 wt %, 0.3 wt % to 1.4 wt %, 0.3 wt % to 1.3 wt %, 0.3 wt % to 1.2 wt %, 0.3 wt % to 1.1 wt %, 0.3 wt % to 1.0 wt % based on the total weight of the ammonia cracking catalyst finally obtained, but is not limited thereto. By supporting lanthanum metal in the above amount range, the performance of the catalyst may be realized without wasting lanthanum metal, and the activity of ruthenium may be maximized to improve the efficiency of the catalyst while ensuring the durability of the catalyst.

The ruthenium metal may be supported in an amount of 0.2 wt % to 1.5 wt %, for example, 0.3 wt % to 1.5 wt %, 0.4 wt % to 1.5 wt %, 0.5 wt % to 1.5 wt %, 0.3 wt % to 1.4 wt %, 0.3 wt % to 1.3 wt %, 0.3 wt % to 1.2 wt %, 0.3 wt % to 1.1 wt %, 0.3 wt % to 1.0 wt % based on the total weight of the ammonia cracking catalyst finally obtained, and is not limited thereto. By supporting ruthenium metal in the above amount range, the catalyst manufacturing cost may be reduced by using a minimum amount of ruthenium metal, while maximizing the performance of the catalyst.

A weight ratio of the porous carrier and the active metal in the functional layer may be 96:4 to 85:15. When the weight ratio of the porous carrier and the active metal in the functional layer falls within the above range, the catalyst including the functional layer may maximize the activation of the ammonia cracking reaction.

The active metal may be included in an amount of 0.5 wt % to 3.0 wt %, for example, 1.0 wt % to 3.0 wt %, 0.5 wt % to 2.5 wt %, 1.0 wt % to 2.5 wt %, 0.5 wt % to 2.0 wt %, 1.0 wt % to 2.0 wt % based on the total weight of the catalyst, but is not limited thereto.

The catalyst may further include an alkali metal. The alkali metal in the catalyst prevents nitrogen gas generated during the ammonia cracking reaction from sticking to the catalyst and increases the reaction rate of the ruthenium, thereby further increasing the efficiency of the catalyst.

The alkali metal may include, for example, sodium, potassium, rubidium, cesium, or a combination thereof, and may be, for example, sodium, potassium, or cesium, and may be, for example, potassium. The potassium (K) has excellent dispersibility within the active metal and prevents nitrogen gas generated during the ammonia cracking reaction from sticking to the catalyst, thereby further improving the stability and efficiency of the catalyst.

The catalyst may include alkali metal and ruthenium in a weight ratio of 3:1 to 1:1, but is not limited thereto. By including alkali metal and ruthenium in the catalyst in the above ratio, the stability of the catalyst may be secured while further improving the efficiency of the catalyst.

The catalyst may include, for example, potassium and ruthenium in a weight ratio of 3:1 to 1:1 but is not limited thereto. The potassium and ruthenium, which are included within the ratio in the catalyst, may further improve efficiency of the catalyst as well as secure stability of the catalyst.

The catalyst may include the alumina-metal foam composite and the functional layer in a weight ratio of 90:10 to 60:40, for example, 85:15 to 60:40, for example 80:20 to 60:40 but is not limited thereto. The alumina-metal foam composite and the functional layer, which are included within the weight ratio ranges in the catalyst, may maximize adhesion between the alumina-metal foam composite and the functional layer and secure excellent reaction efficiency of the catalyst.

The catalyst for ammonia cracking according to an embodiment may maintain high ammonia cracking efficiency at relatively low temperatures, for example, ammonia cracking efficiency of greater than or equal to 95% at 400° C. to 550° C. For example, the catalyst may have ammonia cracking efficiency of greater than or equal to 95% at 400° C. to 540° C., 400° C. to 530° C., 400° C. to 520° C., 400° C. to 510° C., or 400° C. to 500° C. The catalyst has high efficiency under the thermodynamic equilibrium temperature conditions of the ammonia cracking reaction, with which the temperature of the ammonia cracking reaction needs to be no further raised, resultantly increasing energy efficiency of the ammonia cracking reaction.

Another embodiment provides a method of manufacturing the catalyst for ammonia cracking. In the method of manufacturing the catalyst for ammonia cracking described below, the common features of the above-described catalyst are omitted, and the catalyst is not limited by the method described below.

The method of manufacturing the catalyst for ammonia cracking includes a) impregnating a solution including an alumina sol into a metal foam to manufacture an alumina-metal foam composite including a metal foam and an alumina layer on the metal foam; b) supporting an active metal on a porous carrier to prepare a composition for a functional layer; and c) coating the functional layer composition on the alumina-metal foam composite to obtain a final catalyst.

The step a) of manufacturing an alumina-metal foam composite includes a-1) impregnating the solution including an alumina sol into the metal form; and then, a-2) heat-treating a product obtained in the step a-1), thereby manufacturing the alumina-metal foam composite.

The metal foam of the alumina-metal foam composite has a three-dimensional asymmetrical mesh structure and may be formed of an alloy metal obtained from an organic or ceramic skeleton material of an urethane form or a sponge structure by using a shape replication method.

In the step a-1) of impregnating the solution including an alumina sol into the metal form, a method of impregnating the solution including an alumina sol into the metal foam may include dipping or spray coating but is not limited thereto.

The solution including an alumina sol may include an organic binder. If the organic binder is used together, binding strength between the alumina and the metal foam may be further enhanced to allow the alumina to be more evenly coated on the metal foam.

After the step a-1) of impregnating the solution including an alumina sol on the metal foam, the step a-2) of heat-treating the product obtained in the step a-1) may be performed. If the product obtained in the a-1) is heat-treated, the binding strength between the alumina layer and the metal foam in the alumina-metal foam composite may be further increased, and thermal stability of the alumina-metal foam composite may be further enhanced. In addition, if the organic binder is used together in the solution including an alumina sol in the step a-1), the organic binder in the alumina-metal foam composite may be removed by performing the heat treatment of a-2).

The step a-2) of heat treating the product obtained in the a-1) may be performed, for example, at 600° C. to 800° C. The heat treatment within the temperature range may prevent phase change of the alumina and remove the organic binder, further improving stability of the alumina-metal foam composite.

The step b) preparing of the composition for the functional layer may be a step of supporting the active metal on the porous carrier, and may include for example b-1) heat-treating a porous carrier; b-2) supporting a lanthanum precursor solution into the obtained product of the b-1) and then drying and heat-treating it; and b-3) supporting a ruthenium precursor solution into the obtained product of the b-2) and then drying and heat-treating it.

The porous carrier in the functional layer may be used after heat-treating. The heat treatment of the porous carrier may be performed, for example, at 900° C. to 1,000° C. but is not limited thereto and may be performed within any temperature range at which the porous carrier has no more weight loss. If the porous carrier is used after the heat treatment, thermal stability or mechanical characteristics of the porous carrier may be further increased.

The step b-2) of supporting of the lanthanum precursor solution into the obtained product of the step b-1) and then drying and heat-treating it may be a step of allowing the porous carrier subjected to the heat treatment in step b-1) to support lanthanum onto it. For example, if MgAl₂O₄ is used as the porous carrier, La/MgAl₂O₄ may be obtained as a product of the step b-2), but if CaAl₂O₄ is for example used as the porous carrier, La/CaAl₂O₄ may be obtained as a product of the step b-2) but is not limited thereto.

The lanthanum precursor solution in the b-2) may be prepared by dissolving lanthanum nitrate hydrate, lanthanum chloride hydrate, lanthanum acetate hydrate, lanthanum sulfate, or a combination thereof in a solvent, for example, using the lanthanum nitrate hydrate to maximize dispersibility of lanthanum but is not limited thereto.

The solvent used to prepare the lanthanum precursor solution may be, for example, distilled water, ethanol, dihydric alcohol such as ethylene glycol and the like to effectively impregnate the lanthanum metal precursor into the porous carrier.

After impregnating the lanthanum precursor solution into the porous carrier in the b-2), the porous carrier may be dried at 100° C. to 120° C. and then, heat-treated at 500° C. to 600° C. but are not limited to these temperature ranges. Through the drying and the heat treatment, impurities may be removed, for example, if the lanthanum nitrate hydrate is used, residual nitrate may be removed.

The step b-3) of the supporting of a ruthenium precursor solution into the obtained product of the step b-2) and then drying and heat-treating it may be a step of allowing the porous carrier supporting lanthanum in the step b-2) to support ruthenium. For example, if MgAl₂O₄ is used as the porous carrier, a product obtained in the step b-3) may be Ru—La/MgAl₂O₄, and for another example, if CaAl₂O₄ is used as the porous carrier, the product obtained in the step b-3) may be Ru—La/CaAl₂O₄ but is not limited thereto.

The ruthenium precursor solution in the b-3) may be used by dissolving ruthenium nitrate hydrate, ruthenium chloride hydrate, ruthenium acetate hydrate, ruthenium hydroxide hydrate, ruthenium nitrosyl nitrate hydrate, or a combination thereof in a solvent. For example, ruthenium chloride hydrate may be used to maximize the dispersibility of ruthenium, but is not limited thereto.

The solvent used to prepare the ruthenium precursor solution may be, for example, distilled water, ethanol, and dihydric alcohol such as ethylene glycol and the like, wherein the solvent may effectively impregnate the ruthenium metal precursor into the carrier.

The step b-2) of impregnating the ruthenium precursor solution into the obtained product includes supporting ruthenium on the porous carrier on which the lanthanum is supported by pressure-injecting the ruthenium precursor solution.

After supporting the ruthenium on the porous carrier on which the lanthanum is supported in the b-3), drying is performed at 100° C. to 120° C., and then, a heat treatment is performed at 200° C. to 600° C. but are not limited to these temperature ranges. Through the drying and the heat treatment, impurities may be removed.

For example, if ruthenium chloride hydrate is used as the ruthenium metal precursor, after the drying and the heat treatment, a step of removing chloride ions remaining there may be added by using an ion exchange method.

The ion exchange method may be for example performed by washing the composition for a functional layer obtained in the b-3) with a base solution but is not limited thereto. The base solution may be, for example, a solution in which ammonium hydroxide, ammonium nitrate, sodium hydroxide, sodium nitrate, or a combination thereof is dissolved, for example, a solution in which the ammonium hydroxide is dissolved may be used to maximize efficiency of ion exchange but is not limited thereto.

The composition for a functional layer obtained in the b) may be controlled to have a uniform particle size distribution through a milling process. For example, the composition for the functional layer may have particles with an average particle diameter of 0.5 μm to 5 μm, for example, 0.7 μm to 5 μm, 1 μm to 5 μm, 0.5 μm to 4.5 μm, 0.5 μm to 4 μm, 0.5 μm to 3.5 μm, 0.5 μm to 3 μm, 0.7 μm to 3 μm, or 1 μm to 3 μm but is not limited thereto. The composition for the functional layer, whose particles have an average particle diameter within the ranges, may be more uniformly coated on the alumina-metal foam composite.

The catalyst for ammonia cracking according to an embodiment of c) may be finally obtained by coating the composition for a functional layer obtained in the b) on the alumina-metal foam composite obtained in the a). A method of coating the composition for a functional layer on the alumina-metal foam composite in the c) may be, for example, dipping or dispersion coating, for example, the dipping but is not limited thereto.

The composition for a functional layer may be in the form of slurry, which may be obtained by dispersing the composition for a functional layer obtained in the b) in distilled water.

After coating the composition for a functional layer on the alumina-metal foam composite of c-1), drying may be performed at 100° C. to 120° C., and then, a heat treatment may be performed at 200° C. to 600° C. but are not limited to these temperature ranges, and if necessary, the heat treatment may be omitted. Through the drying and the heat treatment, impurities generated in the step c) of obtaining the catalyst may be removed, and activity and durability of the catalyst may be further improved.

The step c of obtaining the final catalyst may further include a step of impregnating the solution including an alkali metal on a product obtained in the step c-1). The additional impregnation of the solution including an alkali metal may further increase stability and performance of the catalyst.

The alkali metal may include, for example, sodium, potassium, rubidium, cesium, or a combination thereof, for example, sodium, potassium, or cesium, for example, the potassium. The solution including the alkali metal refers to a solution in which a precursor of the alkali metal is dissolved in a solvent such as distilled water, ethanol or dihydric alcohol including ethylene glycol, and the like. The precursor of the alkali metal may be nitrate salt, chloride salt, acetate salt, hydroxide salt, or a combination thereof of the alkali metals.

The solution including the alkali metal may be, for example, a solution of potassium nitrate hydrate, potassium chloride hydrate, potassium acetate hydrate, potassium hydroxide hydrate, or a combination thereof dissolved in a solvent. For example, potassium nitrate may be used to maximize the activity of the catalyst.

The alkali metal precursor may be supported in an amount of 4 wt % to 10 wt % based on a total weight of the finally obtained catalyst for ammonia cracking but is not limited thereto. The alkali metal precursor, when supported within the content range, may not only improve efficiency of the catalyst without wasting the alkali metal but also secure durability of the catalyst.

After the c-2) of impregnating the solution including the alkali metal into the product obtained in the step c-1), drying may be performed at 100° C. to 120° C., and then, a heat treatment may be performed 200° C. to 600° C. but are not limited to these temperature ranges, and if necessary, the heat treatment process may be omitted. Through the drying and the heat treatment, impurities generated during the process of supporting the alkali metal may be removed, and activity and durability of the catalyst may be further improved.

A step c-3) of reducing the product obtained in the step c-1) or c-2) may be further included by treating the product obtained in the step c-1) or c-2) under a hydrogen atmosphere. The product obtained in the step c-1) or c-2) may be activated through rapid reduction by the hydrogen treatment. The hydrogen treatment may be performed in a stepwise manner by heating to a target temperature under a nitrogen atmosphere and then, flowing hydrogen gas but is not limited thereto

The hydrogen treatment performed in the stepwise manner as described above may separately reduce metals in the catalyst, while preventing their transformation into an alloy form at high temperatures.

The hydrogen treatment of c-3) may be performed at 400° C. to 600° C. but is not limited thereto. The heat treatment of the catalyst within the temperature range may completely reduce the catalyst, while preventing the catalyst particles from agglomerating or sintering.

The catalyst for ammonia cracking obtained from the above manufacturing method may be used in a cracking reaction of ammonia gas. The cracking reaction of ammonia gas using the catalyst may be performed at 350° C. to 550° C., for example, 450° C. but is not limited thereto. When the ammonia cracking reaction is performed at a temperature of 350° C. to 550° C., efficiency of the ammonia cracking may be maximized by maximizing an amount of hydrogen gas obtained as a result of the ammonia cracking, while minimizing energy costs.

The ammonia cracking reaction may be performed by flowing ammonia gas, for example, at gas space velocity of about 3,000h-1, wherein as the gas space velocity is increased, an amount of hydrogen gas produced by the decomposition of the more ammonia gas may be proportionally increased.

The catalyst for ammonia cracking according to an embodiment may be introduced by using a fixed-bed catalytic reactor during the ammonia cracking reaction, but any reactor capable of maintaining an ammonia cracking reaction temperature may be used without limitation and thus appropriately selected according to purposes and uses of the ammonia cracking.

Hereinafter, the present invention will be described in more detail through examples of the catalyst for ammonia cracking described above and its manufacture. However, the present invention is not technically limited by the following examples.

### EXAMPLES AND COMPARATIVE EXAMPLES

### Manufacture of Catalyst for Ammonia Cracking

### Example 1

A 3-dimensional asymmetric metal foam (AMF) made of an aluminum (Al)-chromium (Cr)-nickel (Ni) alloy and having a cube shape with a side length of 3 mm was used as a metal foam. A solution was prepared by mixing alumina sol, methyl cellulose as an organic binder, and starch in a ratio of 7:2:1. The mixed solution was impregnated into the metal foam by using a dipping method. After the impregnation, clogged pores in the metal foam were opened by using an air knife, the obtained alumina-metal foam composite was dried at 120° C. for 12 hours to completely moisture and then, heat-treated at 700° C. for 6 hours to fix alumina to the metal foam (Al-AMF).

On the other hand, lanthanum nitrate (La(NO₃)₃·xH₂O) as a lanthanum precursor was dissolved in distilled water to prepare a solution, which was impregnated into MgAl₂O₄, which was heat-treated at 600° C. . . . After the impregnation, an aging process was performed for 1 hour, so that the solution in which the lanthanum nitrate was dissolved was sufficiently distributed inside the carrier, drying was performed at 120° C. for 12 hours to completely remove moisture inside the carrier, and a heat treatment was performed at 600° C. for 6 hours to fix a lanthanum metal inside the carrier.

After dissolving ruthenium chloride (RuCl₃·xH₂O) as a ruthenium precursor in distilled water to prepare a solution, a ruthenium metal was supported onto La/MgAl₂O₄ in an impregnation method. Ru—La/MgAl₂O₄ obtained after the supporting was dried at 120° C. for 12 hours to completely remove moisture in the catalyst and then, heat-treated at 200° C. for 6 hours to fix the ruthenium metal inside the carrier. Subsequently, the heat-treated Ru—La/MgAl₂O₄ was additionally washed with ammonia water and with ammonium chloride (NH₄Cl) in an ion exchange method to remove a chloride component remaining there and then, dried at 120° C. for 12 hours. Herein, the ruthenium metal and the lanthanum metal were respectively included in each amount of 2 wt % based on a total amount of the obtained functional layer (Ru—La/MgAl₂O₄).

The obtained Ru—La/MgAl₂O₄ was dispersed in distilled water to prepare a slurry solution, which was ball-milled to have an average particle diameter of 2 μm and then, impregnated into the alumina-metal foam composite (Al-AMF) obtained above in a dipping method. Subsequently, after opening pores clogged in the metal foam by using an air knife, the metal form was dried at 120° C. for 12 hours to remove moisture and then, heat-treated at 200° C. for 6 hours to fix Ru-La/MgAl₂O₄ into the alumina-metal foam composite.

The obtained Ru—La/MgAl₂O₄/Al-AMF was heated to 500° C. under a helium atmosphere and then, rapidly reduced, while flowing hydrogen gas, to finally obtain a catalyst for ammonia cracking. The finally obtained catalyst according to Example 1 was examined with an image microscope, and the results are shown in FIG. 5

The catalyst according to Example 1 was confirmed to include 0.5 wt % of lanthanum, 0.5 wt % of ruthenium, 3 ppm of chloride ion, and 0 ppm of nitrate ions based on its total weight.

### Example 2

A catalyst of Example 2 was prepared in the same manner as in Example 1 except that after obtaining the Ru—La/MgAl₂O₄/Al-AMF catalyst in Example 1, the catalyst was immersed in a potassium nitrate (KNO₃) aqueous solution, dried at 120° C. for 12 hour to completely remove moisture, and additionally heat-treated at 200° C. for 6 hours to include about 6 wt % of a lanthanum metal based on a total weight of a functional layer (Ru—La/MgAl₂O₄). The finally obtained catalyst was confirmed to include about 6 wt % of a potassium metal based on the total weight of the functional layer.

### Example 3

A catalyst of Example 3 was prepared in the same manner as in Example 2 except that CaAl₂O₄ was used instead of MgAl₂O₄ to form the functional layer, and the lanthanum metal was included in an amount of about 2 wt % based on the total weight of the functional layer (Ru—La/CaAl₂O₄). The finally obtained catalyst was confirmed to include about 6 wt % of a potassium metal based on the total weight of the functional layer.

### Comparative Example 1

A catalyst of Comparative Example 1 was prepared in a similar manner to Example 1 except that an alumina (Al₂O₃) pellet was used instead of the alumina-metal foam composite, and a lanthanum metal and a ruthenium metal were sequentially supported onto the Al₂O₃ pellet. The finally obtained catalyst was confirmed to include about 2 wt % of a ruthenium metal based on the total weight of the functional layer.

### Comparative Example 2

A catalyst of Comparative Example 2 was prepared in the same manner as in Example 1 except that an MgAl₂O₄ pellet was used instead of the Al₂O₃ pellet. The obtained catalyst was confirmed to include about 2 wt % of a ruthenium metal based on a total weight of the catalyst.

### Comparative Example 3

A catalyst of Comparative Example 3 was prepared in the same manner as in Example 2 except that an MgAl₂O₄ pellet was used instead of the alumina-metal foam composite. The obtained catalyst was confirmed to include about 2 wt % of a ruthenium metal, about 2 wt % of a lanthanum metal, and about 6 wt % of a potassium metal based on a total weight of the catalyst.

### Comparative Example 4

A catalyst of Comparative Example 4 was prepared in the same manner as in Comparative Example 3 except that about 3 wt % of a ruthenium metal and about 3 wt % of a lanthanum metal were included based on a total weight of the finally prepared catalyst.

### Comparative Example 5

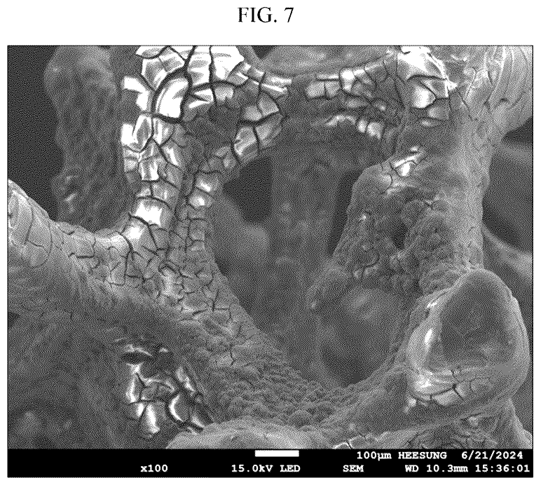

A catalyst of Comparative Example 5 was prepared in the same manner as in Example 1 except that a metal foam with no alumina coating was used. The finally prepared catalyst of Comparative Example 5 was confirmed to include 0.5 wt % of a ruthenium metal based on a total weight of the catalyst (Ru—La/MgAl₂O₄/metal foam). The finally prepared catalyst of Comparative Example 5 was examined with a scanning electron microscope, and the results are shown in FIG. 7.

Specific components and contents of the catalysts according to Examples 1 to 3 and Comparative Examples 1 to 5 are summarized in Table 1. In Table 1, the contents of the active metal and the alkaline metal in Examples 1 to 3 were based on a total weight of each of the functional layers, the contents of the active metal and the alkaline metal in Comparative Examples 1 to 4 were based on a total weight of each of the catalysts, and the content of the active metal and the alkaline metal in Comparative Example 5 was based on a total weight of the carrier and the active metal.

TABLE 1

| | | | | | Ruthenium |
|---|---|---|---|---|---|
| | | | | | metal based on |
| | | | | | a total weight |
| | | | Active | Alkaline | of the catalyst |
| | Support | Carrier | metal | metal | (wt %) |
| Example 1 | alumina-metal | MgAl₂O₄ | 2 wt % Ru- | — | 0.5 |
| | foam | | 2 wt % La | | |
| | composite | | | | |
| Example 2 | alumina-metal | MgAl₂O₄ | 2 wt % Ru- | 6 wt % K | 0.5 |
| | foam | | 6 wt % La | | |
| | composite | | | | |
| Example 3 | alumina-metal | CaAl₂O₄ | 2 wt % Ru- | 6 wt % K | 0.5 |
| | foam | | 2 wt % La | | |
| | composite | | | | |
| Comparative | Al₂O₃ pellet | — | 2 wt % Ru- | — | 2 |
| Example 1 | | | 2 wt % La | | |
| Comparative | MgAl₂O₄ pellet | — | 2 wt % Ru | — | 2 |
| Example 2 | | | −2 wt % La | | |
| Comparative | MgAl₂O₄ pellet | — | 2 wt % Ru- | 6 wt % K | 2 |
| Example 3 | | | 2 wt % La | | |
| Comparative | MgAl₂O₄ pellet | — | 3 wt % Ru- | 6 wt % K | 3 |
| Example 4 | | | 3 wt % La | | |
| Comparative | metal foam | MgAl₂O₄ | 2 wt % Ru- | — | 0.5 |
| Example 5 | | | 2 wt % La | | |

### Evaluation: Evaluation of Ammonia Cracking Reaction Efficiency

An ammonia cracking reaction was carried out by using a fixed bed reaction system, wherein 3 ml of each of the catalysts was charged into a tubular reactor, and after constantly maintaining the reactor at 450° C., ammonia gas was supplied to the reactor constantly at 100 cc/min, while fixing gas hourly space velocity at constant 3,000 h⁻¹. A reaction pressure thereof was set at a normal pressure. After the ammonia cracking reaction, a product produced therefrom was transferred through an injection line to gas chromatography (GC) and then, quantitatively analyzed by using a thermal conductivity detector (TCD).

A conversion rate of ammonia was calculated according to Equation (1), and this ammonia conversion rate was used to evaluate activity of the catalysts.

$$Conversion rate of ammonia ( \% ) = \{ ( number of moles of ammonia before reaction - number of moles of ammonia after reaction ) / ( number of moles of ammonia before reaction ) \} \times 100 \qquad [ Equation ( 1 ) ]$$

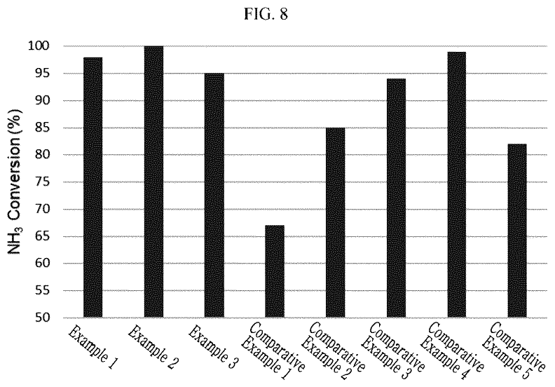

The activity evaluation results of the catalysts for ammonia cracking are shown in a graph of FIG. 8. Referring to FIG. 8, the catalysts of the examples exhibited an ammonia conversion rate of 95% or more, which was generally higher than that of the comparative examples. Accordingly, the catalysts of the examples exhibited excellent efficiency in the ammonia cracking reaction at a relatively low temperature of 450° C. In addition, the catalysts of the examples were confirmed to exhibit a very high ammonia conversion rate despite a low ruthenium content per catalyst volume.

In addition, the catalyst of Comparative Example 5 using a metal foam with no alumina coating exhibited that a functional layer was unstably attached to the metal foam and thus partially detached from the metal foam, as shown in FIG. 7, but the catalyst of FIG. 6, in which a functional layer was coated on an alumina-metal foam composite of Example 1, exhibited that the functional layer was uniformly attached to the alumina-metal foam composite. Referring to FIG. 8, the catalyst of Example 1 exhibited a much higher ammonia conversion rate than that of Comparative Example 5, which confirmed that when using an alumina-metal foam composite, much more excellent ammonia cracking reaction efficiency was obtained than when using a metal foam with no aluminum coating.

Hereinbefore, the certain embodiments of the present disclosure have been described and illustrated, however, it is apparent to a person with ordinary skill in the art that the present disclosure is not limited to the embodiment as described, and may be variously modified and transformed without departing from the spirit and scope of the present disclosure. Accordingly, the modified or transformed embodiments as such may not be understood separately from the technical ideas and aspects of the present disclosure, and the modified embodiments are within the scope of the claims of the present disclosure.

What is claimed is:

1. A catalyst for ammonia cracking, comprising
an alumina-metal foam composite; and
a functional layer on the alumina-metal foam composite,
wherein the alumina-metal foam composite comprises
a metal foam, and
an alumina layer on the metal form, and
the functional layer comprises,
a porous carrier, and
an active metal supported in the porous carrier.

2. The catalyst for ammonia cracking of claim 1, wherein the active metal is included in an amount of 0.5 wt % to 3.0 wt % based on a total weight of the catalyst.

3. The catalyst for ammonia cracking of claim 1, wherein the alumina in the alumina layer comprises gamma-alumina, delta-alumina, eta-alumina, theta-alumina, or a combination thereof.

4. The catalyst for ammonia cracking of claim 1, wherein the metal form comprises an alloy in which at least two or more of aluminum, nickel, chromium, copper, titanium, silver, tungsten, and iron are combined.

5. The catalyst for ammonia cracking of claim 1, wherein the metal foam has a three-dimensional asymmetric structure.

6. The catalyst for ammonia cracking of claim 1, wherein the metal foam has a porosity of greater than or equal to 80 vol %.

7. The catalyst for ammonia cracking of claim 1, wherein a weight ratio of the metal foam and the alumina layer in the alumina-metal foam composite is 99:1 to 95:5.

8. The catalyst for ammonia cracking of claim 1, wherein the active metal comprises ruthenium (Ru), lanthanum (La), nickel (Ni), cobalt (Co), iron (Fe), cerium (Ce), or a combination thereof.

9. The catalyst for ammonia cracking of claim 8, wherein the active metal comprises lanthanum and ruthenium in a weight ratio of 3:1 to 1:1.

10. The catalyst for ammonia cracking of claim 1, wherein the porous carrier is a spinel-type carrier.

11. The catalyst for ammonia cracking of claim 1, wherein a weight ratio of the porous carrier and the active metal in the functional layer is 96:4 to 85:15.

12. The catalyst for ammonia cracking of claim 1, wherein the catalyst further comprises potassium, sodium, rubidium, cesium, or a combination thereof.

13. The catalyst for ammonia cracking of claim 12, wherein the catalyst comprises potassium and ruthenium in a weight ratio of 3:1 to 1:1.

14. The catalyst for ammonia cracking of claim 1, wherein the catalyst comprises an alumina-metal foam composite and a functional layer in a weight ratio of 90:10 to 60:40.

15. A method of manufacturing a catalyst for ammonia cracking, comprising
a) impregnating a solution including an alumina sol into a metal foam to manufacture an alumina-metal foam composite including a metal foam and an alumina layer on the metal foam;
b) supporting an active metal on a porous carrier to prepare a composition for a functional layer; and
c) coating the functional layer composition on the alumina-metal foam composite to obtain a final catalyst.

16. The method of claim 15, wherein in the a) manufacturing of the alumina-metal foam composite, the solution including the alumina sol further comprises an organic binder.

17. The method of claim 15, wherein the a) manufacturing of the alumina-metal foam composite further comprises,
a-1) supporting the solution including the alumina sol on a metal form; and then
a-2) heat treating a product obtained in the a-1),
to manufacture the alumina-metal foam composite.

18. The method of claim 15, wherein the b) preparing of the composition for the functional layer comprises,
b-1) heat-treating a porous carrier;
b-2) supporting a lanthanum precursor solution into the obtained product of the b-1) and then drying and heat-treating it; and
b-3) supporting a ruthenium precursor solution into the obtained product of the b-2) and then drying and heat-treating it.

19. The method of claim 15, wherein the c) obtaining of the final catalyst comprises,
c-1) carrying out drying and heat treatment after supporting a solution including the composition for the functional layer on the alumina-metal foam composite.

20. The method of claim 19, wherein after the c-1),
the method further comprises
c-2) supporting a solution including an alkali metal into the obtained product of the c-1), followed by drying and heat treatment.
